(19) United States
(12) Patent Application Publication
(10) Pub. No.: US 2024/0021777 A1
(43) Pub. Date: Jan. 18, 2024

(54) COATED ANODE FOR A LITHIUM BATTERY

(71) Applicant: University of Maryland, College Park, College Park, MD (US)

(72) Inventors: Lianbing HU, Rockville, MD (US); Eric D. WACHSMAN, Fulton, MC (US); Boyang LIU, Columbia, MD (US); Liu ZHANG, Berwyn Heights, MD (US); Shaomao XU, College Park, MD (US); Dennis MCOWEN, Washington, DC (US); Chunpeng YANG, Berwyn Heights, MD (US); Hua XIE, College Park, MD (US)

(21) Appl. No.: 18/220,700

(22) Filed: Jul. 11, 2023

Related U.S. Application Data
(60) Provisional application No. 63/389,306, filed on Jul. 14, 2022.

(51) Int. Cl. H01M 4/04; H01M 10/0525; H01M 4/133; H01M 50/46; H01M 50/434; H01M 4/587; H01M 4/1393

(52) U.S. Cl. CPC H01M 4/0426; H01M 10/0525; H01M 4/133; H01M 50/46; H01M 50/434; H01M 4/587; H01M 4/1393; H01M 2004/027

(57) ABSTRACT

The present disclosure provides an anode assembly for a lithium ion battery. The anode assembly comprises an anode, a ceramic separator, and an amorphous carbon coating. The anode comprises a first porous ceramic matrix having pores. The ceramic separator layer is coupled to the anode. The amorphous carbon coating is disposed at least partially on a surface of the first porous ceramic matrix. The present disclosure also provides a lithium-ion battery. The present disclosure further provides a method of forming an anode assembly for a lithium-ion battery.

### CROSS-REFERENCE TO RELATED APPLICATIONS

This application claims the benefit of U.S. Provisional Application No. 63/389,306, filed on Jul. 14, 2022, the disclosure of which is incorporated herein by reference in its entirety.

### GOVERNMENT LICENSE RIGHTS

This invention was made with government support under contract no. DE-AR0000787 awarded by U.S. Department of Energy Advanced Research Projects Agency and contract no. DE-EE0008201 awarded by U.S. Department of Energy Office of Energy Efficiency and Renewable Energy. The U.S. government has certain rights in the invention.

### FIELD OF THE INVENTION

The present invention relates to batteries including lithium batteries, solid state batteries, and hybrid batteries.

### BACKGROUND

Lithium (Li) metal is considered an ideal electrode (e.g., anode) active material for next generation energy storage systems due to its low reduction potential (−3.04 V as compared to a standard hydrogen electrode) and high specific capacity (3860 mAh/g). However, Li electrodes (e.g., anodes) have a tendency to form dendrites that create short circuits. Moreover, organic liquid electrolytes are highly flammable, creating safety concerns. As an alternative, inorganic solid-state electrolytes (SSEs) have been proposed due to their higher mechanical strength, which suppresses Li dendrites, and their lack of flammability. Despite the attractive properties of SSEs, the interface between the electrolyte and Li metal anode active material tends to degrade over cycling as Li stripping and plating disrupts the continuous electron and ion conduction pathways. This disruption results in inhomogeneous deposition of the Li metal on the electrolyte and current collector, thereby creating uneven, high local current densities that further exacerbate the Li plating and stripping process until the interface between the anode and electrolyte becomes completely disrupted.

As such, there remains a need to provide improved anode assemblies for energy storage systems.

### SUMMARY OF THE INVENTION

In one aspect, the present invention provides an anode assembly for a lithium-ion battery. The anode assembly comprises an anode, a ceramic separator layer, and an amorphous coating. The anode comprises a first porous ceramic matrix comprising a plurality of pores. The ceramic separator layer is coupled to the anode. The amorphous carbon coating is disposed on at least a portion of a surface of the first porous ceramic matrix.

In some embodiments, the anode assembly further comprises an anode-side current collector coupled to at least a portion of the first porous ceramic matrix. In other embodiments, the ceramic separator layer is substantially free of the amorphous carbon coating.

In some embodiments, the amorphous carbon coating is electron conductive. In other embodiments, the amorphous carbon coating is ion conductive. In some embodiments, the amorphous carbon coating is electron conductive and ion conductive. And, in some embodiments, the amorphous carbon coating is disposed at least partially on the surface of the first porous ceramic matrix in one or more pores.

In some embodiments, at least a portion of the amorphous carbon coating has a thickness of from about 1 nm to about 800 nm. For example, at least a portion of the amorphous carbon coating may have a thickness of from about 150 nm to about 650 nm. In other embodiments, at least a portion of the amorphous carbon coating has a thickness of from about 250 nm to about 550 nm.

In some embodiments, the amorphous carbon coating has an affinity for an anode active material. In other embodiments, the amorphous carbon coating has a flake-stacked structure.

In some embodiments, the anode has a thickness of from about 1 μm to about 100 μm. In other embodiments, the anode has an apparent porosity of from about 20% to about 80%.

In another aspect, the present invention provides a lithium-ion battery. The lithium-ion battery comprises an anode assembly. The anode assembly comprises an anode, a ceramic separator, an amorphous carbon coating, and an anode-side current collector. The anode comprises a first porous ceramic matrix having pores. The ceramic separator layer is coupled to the anode. The amorphous carbon coating is disposed at least partially on a surface of the first porous ceramic matrix. The anode-side current collector is coupled to at least a portion of the first porous ceramic matrix. The lithium ion-battery further comprises a cathode and at least one of an anode active material and a cathode active material. When present, the anode active material is disposed in the pores of the anode and comprises lithium. When present, the cathode active material is disposed in the cathode.

In some embodiments, the ceramic separator layer is substantially free of the amorphous carbon coating.

In some embodiments, the amorphous carbon coating is electron conductive. In some embodiments, the amorphous carbon coating is ion conductive.

In some embodiments, the amorphous carbon coating is disposed at least partially on the surface of the first porous ceramic matrix in one or more pores.

In some embodiments, at least a portion of the amorphous carbon coating has a thickness of from about 1 nm to about 800 nm. In other embodiments, at least a portion of the amorphous carbon coating has a thickness of from about 150 nm to about 650 nm. And, in some embodiments, at least a portion of the amorphous carbon coating has a thickness of from about 250 nm to about 550 nm.

In some embodiments, the amorphous carbon coating has an affinity for the anode active material. And, in some embodiments, the amorphous carbon coating has a flake-stacked structure.

In some embodiments, the anode has a thickness of from about 1 μm to about 100 μm. In other embodiments, the anode has an apparent porosity of from about 20% to about 80%.

In some embodiments, the anode active material has a nucleation overpotential of from about 0.1 mV to about 5 mV at 0.5 mA/cm². In other embodiments, the anode active material has a nucleation overpotential of from about 0.25 mV to about 2.5 mV at 0.5 mA/cm². In some embodiments, the anode active material has a nucleation overpotential of from about 0.5 mV to about 1.5 mV at 0.5 mA/cm².

In some embodiments, the anode active material has a morphology substantially free of sharp edges after infiltration.

In some embodiments, the cathode comprises a second porous ceramic matrix having pores. And, in some embodiments, the cathode has a thickness of from about 1 μm to about 100 μm.

In some embodiments, the ceramic separator layer has a thickness of from about 1 μm to about 100 μm.

In some embodiments, the cathode active material comprises sulfur.

Another aspect of the present invention provides a method of forming an anode assembly for a lithium-ion battery comprising:
(a) providing an anode and a ceramic separator layer coupled to the anode, wherein the anode comprises a porous ceramic matrix having pores; and
(b) disposing an amorphous carbon coating at least partially on a surface of the porous ceramic matrix to form the anode assembly.

In some implementations, step (b) comprises disposing an amorphous carbon coating at least partially on the surface of the porous ceramic matrix in a vacuum chamber. In other implementations, step (b) comprises disposing an amorphous carbon coating at least partially on the surface of the porous ceramic matrix at room temperature.

In some implementations, step (b) comprises disposing an amorphous carbon coating at least partially on the surface of the porous ceramic matrix via a sputtering device. In some implementations, the sputtering device comprises a carbon source. And, in some implementations, the carbon source is a graphite rod.

In some implementations, the method further comprises
(c) masking at least a portion of the ceramic separator layer prior to step (b).

In some implementations, the amorphous carbon coating is electron conductive. In some implementations, the amorphous carbon coating is ion conductive.

In some implementations, the amorphous carbon coating is disposed at least partially on the surface of the porous ceramic matrix in one or more pores.

In some implementations, at least a portion of the amorphous carbon coating has a thickness of from about 1 nm to about 800 nm. In other implementations, at least a portion of the amorphous carbon coating has a thickness of from about 150 nm to about 650 nm. And in some implementations, at least a portion of the amorphous carbon coating has a thickness of from about 250 nm to about 550 nm.

In some implementations, the amorphous carbon coating has a flake-stacked structure.

In some implementations, the method further comprises
(d) setting the amorphous carbon coating in a dry environment after step (b).

### BRIEF DESCRIPTION OF THE DRAWINGS

The figures below are provided by way of example and are not intended to limit the scope of the claimed invention.

FIG. 1(a) is a schematic of an anode assembly having an inferior SSE interface after stripping and plating with lithium metal.

FIG. 1(b) is a schematic of an anode assembly comprising an amorphous carbon coating on the solid-state electrolyte according to one embodiment after stripping and plating with lithium metal.

FIG. 2(a) is a scanning electron micrograph (SEM) cross-section of a garnet-type solid electrolyte with a trilayer (porous-dense-porous) structure.

FIG. 2(b) is a schematic of an anode assembly comprising an amorphous carbon.

FIG. 2(c) is X-ray diffraction (XRD) patterns for an anode assembly comprising an amorphous carbon coating according to one embodiment and an anode assembly without an amorphous carbon coating.

FIG. 2(d) is a SEM cross-section of an anode assembly comprising an amorphous carbon coating according to one embodiment, with Raman spectra of the amorphous carbon coating inset.

FIG. 2(e) is a SEM of an anode assembly without an amorphous carbon coating.

FIG. 2(f) is a SEM of an anode assembly comprising an amorphous carbon coating according to one embodiment, wherein the amorphous carbon coating has a flake-stacked structure.

FIG. 2(g) is another SEM of the anode assembly comprising an amorphous carbon coating as shown in FIG. 2(f), wherein the amorphous carbon coating has a flake-stacked structure.

FIG. 2(h) is another SEM of the anode assembly comprising an amorphous carbon coating as shown in FIG. 2(f), wherein the amorphous carbon coating has a flake-stacked structure.

FIG. 2(i) is another SEM of the anode assembly comprising an amorphous carbon coating as shown in FIG. 2(f), showing a thickness of the amorphous carbon coating.

FIG. 3(a) is a schematic of an anode assembly without an amorphous carbon coating.

FIG. 3(b) is a SEM of the anode assembly of FIG. 3(a) showing lithium infiltration.

FIG. 3(c) is a close-up view of the SEM of FIG. 3(b).

FIG. 3(d) is a schematic of an anode assembly comprising an amorphous carbon coating according to one embodiment.

FIG. 3(e) is a SEM of the anode assembly of FIG. 3(d) showing lithium infiltration.

FIG. 3(f) is a close-up view of the SEM of FIG. 3(e).

FIG. 3(g) is energy-dispersive X-ray spectroscopy (EDS) images of the anode assembly of FIG. 3(d).

FIG. 4(a) is a schematic of a lithium plating/stripping test for an anode assembly without an amorphous carbon coating and an anode assembly comprising an amorphous carbon coating according to one embodiment.

FIG. 4(b) is a comparison of voltage profiles for the anode assembly without an amorphous carbon coating and the anode assembly comprising an amorphous carbon coating.

FIG. 4(c) is a comparison of cycling voltage profiles for the anode assembly without an amorphous carbon coating and the anode assembly comprising an amorphous carbon coating.

FIG. 4(d) is a close-up view of the cycling voltage profile for the anode assembly without the amorphous carbon coating of FIG. 4(c).

FIG. 4(e) is a close-up view of the cycling voltage profile for the anode assembly comprising an amorphous carbon coating of FIG. 4(c).

FIG. 4(f) is another close-up view of the cycling voltage profile for the anode assembly comprising an amorphous carbon coating of FIG. 4(c).

FIG. 4(g) is another close-up view of the of the cycling voltage profile for the anode assembly without and amorphous carbon coating of FIG. 4(c).

FIG. 4(h) is a SEM of a porous-dense structure used in the fabrication of the anode assemblies of FIG. 4(a).

FIG. 5(a) is an electrochemical impedance spectroscopy (EIS) profile of the anode assembly comprising an amorphous carbon coating of FIG. 4(a) before cycling.

FIG. 5(b) is an EIS profile of the anode assembly comprising an amorphous carbon coating of FIG. 4(a) after cycling.

FIG. 5(c) is a SEM image of the lithium metal and dense layer interface of the anode assembly comprising the amorphous carbon coating of FIG. 4(a) after 600 hours of cycling.

FIG. 6(a) is a schematic of the anode assembly without an amorphous carbon coating of FIG. 4(a) after cycling, showing lithium deposition outside the porous layer of the anode assembly.

FIG. 6(b) is a SEM of the anode assembly of FIG. 4(a) after cycling, showing layered and porous lithium deposition on a surface of the anode.

FIG. 6(c) is a SEM of the anode assembly of FIG. 4(a) after cycling, showing pores substantially free of lithium.

FIG. 6(d) is a schematic of the anode assembly comprising an amorphous carbon coating of FIG. 4(a) after cycling, showing lithium deposition inside the pores of the anode assembly.

FIG. 6(e) is a SEM of the anode assembly comprising an amorphous carbon coating of FIG. 4(a) after cycling, showing lithium deposition on a surface of the anode.

FIG. 6(f) is a SEM of the anode assembly comprising an amorphous carbon coating of FIG. 4(a) after cycling, showing deposition of lithium in the pores.

FIG. 6(g) is a schematic of a lithium-ion battery comprising an anode assembly without an amorphous carbon coating and a cathode comprising sulfur.

FIG. 6(h) is an electrochemical impedance spectroscopy (EIS) profile of the lithium-ion battery of FIG. 6(g) before and after cycling at room temperature.

FIG. 6(i) is an SEM of the lithium-ion battery of FIG. 6(g) after cycling, showing depletion of lithium in the pores of the anode assembly.

FIG. 6(j) is a schematic of a lithium-ion battery according to one embodiment comprising an anode assembly comprising an amorphous carbon coating and a cathode comprising sulfur.

FIG. 6(k) is an EIS profile of the lithium-ion battery of FIG. 6(j) before and after cycling at room temperature.

FIG. 6(l) is an SEM of the lithium-ion battery of FIG. 6(j) after cycling, showing lithium in the pores of the anode assembly.

FIG. 7(a) is another SEM of the anode assembly of FIG. 4(a) after cycling, with Li metal accumulated outside the pores of the anode assembly.

FIG. 7(b) is another SEM of the Li-garnet interface morphology of the pores of anode assembly comprising an amorphous carbon coating of FIG. 4(a) at the initial stage of the Li plating process.

FIG. 8(a) is a galvanostatic charge/discharge voltage profile of the lithium-ion battery of FIG. 6(g).

FIG. 8(b) is a galvanostatic charge/discharge voltage profile of the lithium-ion battery of FIG. 6(j).

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

The presently disclosed subject matter relates generally to a lithium-ion battery system, several components of this battery system, and their methods of fabrication. The present lithium-ion battery system offers improved performance and safety to standard solid-state metal batteries. The lithium-ion battery system may include several components including, but not limited to, lithium metal anodes and garnet structural portions, such as separators and porous region(s). In certain embodiments, the lithium-ion battery system can include a 3D host that conducts ions or electrons and may be used for Li metal anodes. This 3D host may include a garnet-type Li-ion conductor with a porous-dense-porous trilayer structure or a porous-dense bilayer with a current collector that can be a conductive layer, for which many materials are suitable. Included in the present disclosure is an anode framework that may conduct electrons or ions. In some embodiments, the structure can include a cathode structure that includes a liquid as a part of the electrolyte, and this cathode structure can be combined with embodiments of anodes anode frameworks disclosed herein. The structure and method of fabrication can result in a lithium-ion battery system component that can offer reliable cycling performance and/or high current density, which can in some embodiments measure reach 1 mA/cm² or higher. Also, the present lithium-ion battery system reduces the effect or likelihood of dendrite formation. The present disclosure also addresses issues associated with the interfacial contact between solid-state electrolyte materials and Li metal anodes. In one example embodiment, the present invention produces all-solid-state Li metal batteries with high energy densities and long-term stability.

### I. DEFINITIONS

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

As used herein, when an element is referred to as being “on,” “engaged to,” “connected to,” “attached to,” or “coupled to” another element, it may be directly on, engaged, connected, attached, or coupled to the other element, or intervening elements may be present. In contrast, when an element is referred to as being “directly on,” “directly engaged to,” “directly connected to,” “directly attached to,” or “directly coupled to” another element, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As used herein, the term “lithium-ion battery” refers to a rechargeable secondary cell or battery (i.e., plurality of cells) wherein the anode active material comprises lithium ions. In some embodiments, the lithium-ion battery may be a solid-state lithium-ion battery.

As used herein, the term “anode assembly” refers to an assembly comprising an anode, a ceramic separator layer, and an amorphous carbon coating.

As used herein, the term “anode” refers to the negative electrode from which electrons flow during the discharging phase in the battery. The anode comprises a first porous ceramic matrix having pores. The anode may be referred to herein as “a porous layer”.

As used herein, the term “ceramic separator layer” refers to a layer disposed between the anode and the cathode and comprised of a ceramic material. In some embodiments, the ceramic separator layer is substantially free of pores (e.g., having an apparent porosity of less than 50%, having an apparent porosity of less than 40%, having an apparent porosity of less than 30%, having an apparent porosity of less than 20%, having an apparent porosity of less than 15%, having an apparent porosity of less than 10%, having an apparent porosity of less than 5%, or having an apparent porosity of less than 1%). And, in some embodiments, the ceramic separator layer is free of pores. The ceramic separator layer may be referred to herein as “a dense layer”.

As use herein, the term “amorphous carbon coating” refers to a coating comprising carbon disposed at least partially on a surface of the first porous ceramic matrix. For example, the amorphous carbon coating may be disposed on at least 0.1%, at least 1%, at least 5%, at least 10%, at least 20%, at least 30%, at least 40%, at least 50%, at least 60%, at least 70%, at least 80%, at least 90%, at least 99%, or 100% of the surface of the first porous ceramic matrix.

As used herein, the term “cathode” refers to the positive electrode into which electrons flow during the discharging phase in the battery. In some embodiments, the cathode comprises a second porous ceramic matrix having pores. The cathode may be referred to herein as “a porous layer”.

As used herein, the term “anode-side current collector” refers to a current collector coupled to at least a portion of the anode (e.g., the first porous ceramic matrix). The anode-side current collector collects current generated at the anode. Materials that can serve as current collectors include but are not limited to stainless steel, copper, nickel, titanium, gold, and carbon.

As used herein, the term “anode active material” refers to an anode material suitable for use in a lithium-ion battery. The anode active material is disposed in the pores of the anode (i.e., the pores of the first porous ceramic matrix). The anode active material comprises lithium. Exemplary anode active materials include, but are not limited to, lithium metal anode materials and lithium compound anode materials.

As used herein, the term “cathode active material” refers to a cathode material suitable for use in a lithium-ion battery. The cathode active material is disposed in the cathode. Exemplary cathode active materials include, but are not limited, to lithium compound cathode materials (e.g., LiCoO₂, LiMnO₂, LiNiₓMn_{y}Co_{z}O₂, LiFePO₄, and the like), sulfur-based cathode materials (e.g., S, LiₓS), oxygen, or air cathodes.

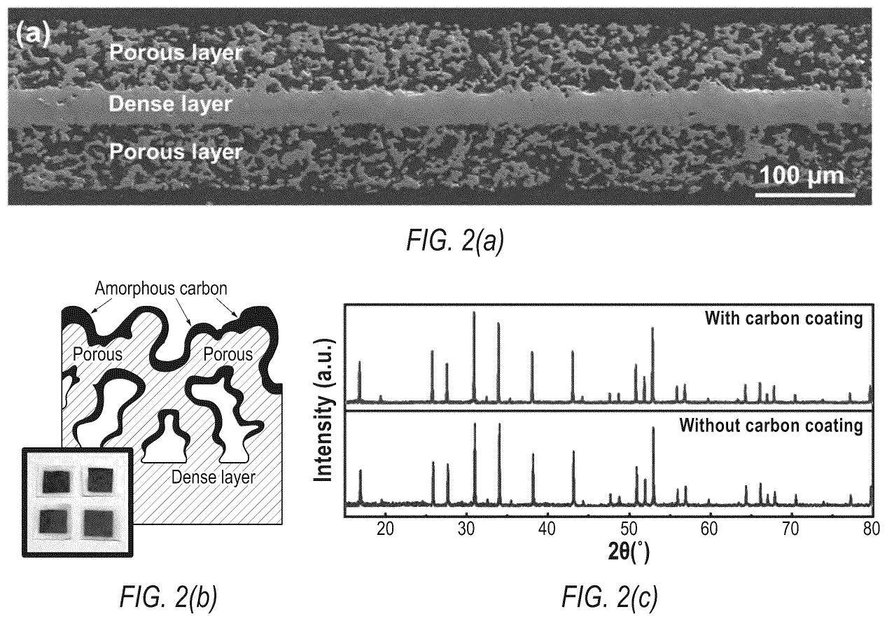

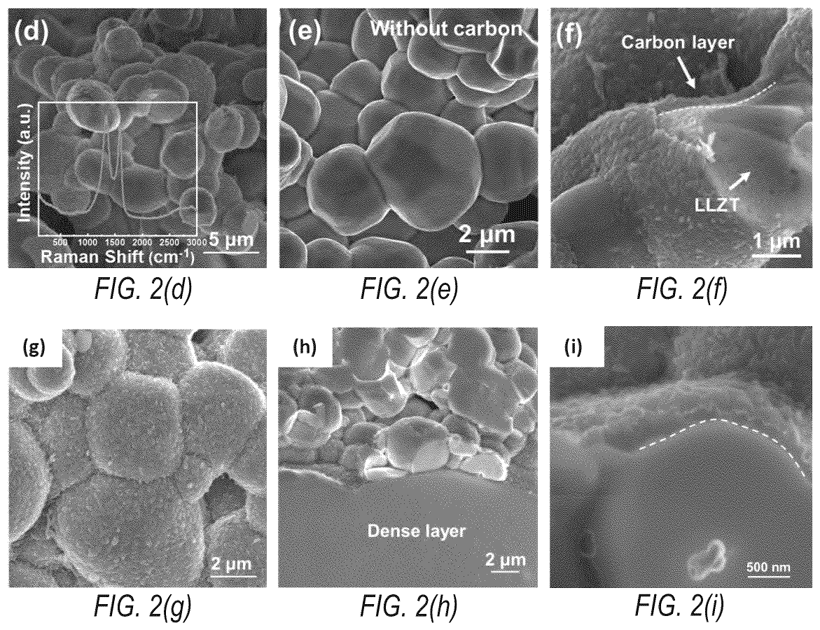

As used herein, the term “apparent porosity” refers to the open (or accessible) porosity (i.e., porosity that excludes volume(s) from sealed or closed pores, cells, or voids). Apparent porosity can be represented as a fraction or percentage of the volume of open pores, cells, or voids over the total volume. In this disclosure, apparent porosity was calculated by image analysis of the porous layer (e.g., in FIG. 2a).

### II. ANODE ASSEMBLY

In one aspect, the present invention provides an anode assembly. The anode assembly comprises an anode, a ceramic separator layer, and an amorphous carbon coating. In some embodiments, the anode assembly further comprises an anode-side current collector.

### A. Anode

The anode comprises a first porous ceramic matrix having pores. In some embodiments, the first porous ceramic matrix comprises a garnet material. Non-limiting examples of garnet materials include lithium garnet materials, doped lithium garnet materials, lithium garnet composite materials, and combinations thereof. Non-limiting examples of lithium garnet materials include Lia-phase lithium garnet SSE materials (e.g., Li₃M¹Te₂O₁₂, where M¹ is a lanthanide such as Y, Pr, Nd, Sm, Eu, Gd, Tb, Dy, Ho, Er, Tm, Yb, Lu, Zr, Ta, or a combination thereof and Li₃₊ₓNd₃Te₂₋ₓO₁₂, where x is 0.05 to 1.5; Li₅-phase lithium garnet SSE materials (e.g., Li₅La₃M²₂O₁₂, where M² is Nb, Zr, Ta, Sb, or a combination thereof, cation-substituted Li₅La₃M₂²O₁₂ such as, for example, Li₆M¹La₃M²₂O₁₂, where M¹ is Mg, Ca, Sr, Ba, or combinations thereof, and Li₇La₃M₂²O₁₂, where M² is Zr, Sn, or a combination thereof); Li₆-phase lithium garnet SSE materials (e.g., Li₆M¹La₂M₂²O₁₂, where M¹ is Mg, Ca, Sr, Ba, or a combination thereof and M² is Nb, Ta, or a combination thereof); cation-doped Li₆La₂BaTa₂O₁₂; cation-doped Li₆BaY₂M₂²O₁₂, where M² is Nb, Ta, or a combination thereof and the cation dopants are barium, yttrium, zinc, or combinations thereof, an Li₇-phase lithium garnet SSE material (e.g., cubic Li₇La₃Zr₂O₁₂ and Li₇Y₃Zr₂O₁₂); cation-doped Li₇La₃Zr₂O₁₂; Li₅₊₂ₓLa₃, Ta₂₋ₓO₂, where x is 0.1 to 1, Li_{6.8}(La_{2.95},Ca_{0.5})(Zr_{1.75},Nb_{0.25})O₁₂ (LLCZN), Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂), lithium garnet composite materials (e.g., lithium garnet-conductive carbon matrix or composites with other materials). Other examples of lithium-ion-conducting SSE materials include cubic garnet-type materials such as 3 mol % YSZ-doped Li_{7.6}La₃Zr_{1.94}Y_{0.06}O₁₂ and 8 mol % YSZ-doped Li_{7.16}La₃Zr_{1.94}Y_{0.06}O₁₂. Additional examples of suitable Li-garnet SSE materials include, but are not limited to, Li₅La₃Nb₂₀₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₇Y₃Zr₂O₁₂, Li_{6.75}BaLa₂Nb_{1.75}ZnO_{0.25}O₁₂, or Li_{6.75}BaLa₂Ta_{1.75}Zn_{0.25}O₁₂. In some embodiments, the garnet material is, for example, Li₇La_{3-y}M¹_{y}Zr_{2-z}M²_{z}O₁₂, wherein x greater than 0 and less than 2, M¹ is chosen from Ba, Ca, Y, and combinations thereof, and M² is chosen from Nb, Ta, and combinations thereof. In some embodiments, the garnet material is Li_{6.75}La₃Zr_{1.75}Ta_{0.25}O₁₂ (LLZT), Li_{6.75}La_{2.75}Zr_{1.75} Ca_{0.25}Nb_{0.25}O₁₂ (LLZCN), Li₅La₃Nb₂O₁₂ (LLZNO), Li₇La₃Zr₂O₁₂ (LLZ), Li₅La₃Ta₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li_{6.75}BaLa₂Nb_{1.75}Zn_{0.25}O₁₂, Li_{6.75}BaLa₂Ta_{1.75}Zn_{0.25}O₁₂, or any combination thereof. In some embodiments, the garnet material is LLZT.

In some embodiments, the anode has an apparent porosity of from about 20% to about 80%. In other embodiments, the anode has an apparent porosity of from about 35% to about 75%. In some embodiments, the anode has an apparent porosity of from about 45% to about 65%. And, in some embodiments, the anode has an apparent porosity of from about 50% to about 60%.

In some embodiments, the anode has a thickness of from about 1 μm to about 100 μm. In other embodiments, the anode has a thickness of from about 20 μm to about 80 μm. In some embodiments, the anode has a thickness of from about 30 μm to about 70 μm. In some embodiments, the anode has a thickness of from about 50 μm to about 70 μm. And, in some embodiments, the anode has a thickness of about 60 μm.

### B. Ceramic Separator Layer

The ceramic separator layer is coupled to the anode. The ceramic separator layer may comprise any suitable material. In some embodiments, the ceramic separator layer comprises a garnet material. When the ceramic separator layer comprises a garnet material, the garnet material of the ceramic separator layer may be the same as the garnet material of the anode. In other embodiments, when the ceramic separator layer comprises a garnet material, the garnet material of the ceramic separator layer may be different from the garnet material of the anode. For example, the ceramic separator layer may comprise lithium garnet materials, doped lithium garnet materials, lithium garnet composite materials, and combinations thereof. Non-limiting examples of lithium garnet materials include Lia-phase lithium garnet SSE materials (e.g., Li₃M¹Te₂O₁₂, where M¹ is a lanthanide such as Y, Pr, Nd, Sm, Eu, Gd, Tb, Dy, Ho, Er, Tm, Yb, Lu, Zr, Ta, or a combination thereof and Li₃₊ₓNd₃Te₂₋ₓO₁₂, where x is 0.05 to 1.5; Li₅-phase lithium garnet SSE materials (e.g., Li₅La₃M₂²O₁₂, where M² is Nb, Zr, Ta, Sb, or a combination thereof, cation-substituted Li₅La₃M₂²O₁₂ such as, for example, Li₆M¹La₃M₂²O₁₂, where M¹ is Mg, Ca, Sr, Ba, or combinations thereof, and Li₇La₃M₂²O₁₂, where M² is Zr, Sn, or a combination thereof); Lib-phase lithium garnet SSE materials (e.g., Li₆M¹La₂M²₂O₁₂, where M¹ is Mg, Ca, Sr, Ba, or a combination thereof and M 2 is Nb, Ta, or a combination thereof); cation-doped Li₆La₂BaTa₂O₁₂; cation-doped Li₆BaY₂M²₂O₁₂, where M² is Nb, Ta, or a combination thereof and the cation dopants are barium, yttrium, zinc, or combinations thereof, an Li₇-phase lithium garnet SSE material (e.g., cubic Li₇La₃Zr₂O₁₂ and Li₇Y₃Zr₂O₁₂); cation-doped Li₇La₃Zr₂O₁₂; Li₅₊₂ₓLa₃, Ta₂₋ₓO₂, where x is 0.1 to 1, Li_{6.8}(La_{2.95},Ca_{0.5})(Zr_{1.75},Nb_{0.25})O₁₂ (LLCZN), Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂), lithium garnet composite materials (e.g., lithium garnet-conductive carbon matrix or composites with other materials). Other examples of lithium-ion-conducting SSE materials include cubic garnet-type materials such as 3 mol % YSZ-doped Li_{7.6}La₃Zr_{1.94}Y_{0.06}O₁₂ and 8 mol % YSZ-doped Li_{7.16}La₃Zr_{1.94}Y_{0.06}O₁₂. Additional examples of suitable Li-garnet SSE materials include, but are not limited to, Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₇Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂. In some embodiments, the garnet material is, for example, Li₇₋ₓLa_{3-y}M¹_{y}Zr_{2-z}O₁₂, wherein x greater than 0 and less than 2, M¹ is chosen from Ba, Ca, Y, and combinations thereof, and M² is chosen from Nb, Ta, and combinations thereof. In some embodiments, the garnet material is Li_{6.75}La₃Zr_{1.75}Ta_{0.25}O₁₂ (LLZT), Li_{6.75}La_{2.75}Zr_{1.75}Ca_{0.25}Nb_{0.25}O₁₂ (LLZCN), Li₅La₃Nb₂O₁₂ (LLZNO), Li₇La₃Zr₂O₁₂ (LLZ), Li₅La₃Ta₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li_{6.75}BaLa₂Nb_{1.75}Zn_{0.25}O₁₂, Li_{6.75}BaLa₂Ta_{1.75}Zn_{0.25}O₁₂, or any combination thereof. In some embodiments, the garnet material is LLZT.

In some embodiments, the ceramic separator layer is substantially free of pores (e.g., having an apparent porosity of less than 50%, having an apparent porosity of less than 40%, having an apparent porosity of less than 30%, having an apparent porosity of less than 20%, having an apparent porosity of less than 15%, having an apparent porosity of less than 10%, having an apparent porosity of less than 5%, or having an apparent porosity of less than 1%). And, in some embodiments, the ceramic separator layer is free of pores.

In some embodiments, the ceramic separator layer has a thickness of from about 1 μm to about 100 μm. In other embodiments, the ceramic separator layer has a thickness of from about 20 μm to about 80 μm. In some embodiments, the ceramic separator layer has a thickness of from about 20 μm to about 70 μm. In some embodiments, the ceramic separator layer has a thickness of from about 20 μm to about 50 μm. In some embodiments, the ceramic separator layer has a thickness of from about 20 μm to about 40 μm. And, in some embodiments, the ceramic separator layer has a thickness of about 30 μm.

In some embodiments, the anode and the ceramic separator layer are a bilayer structure as described in United States Patent Application Publication No. 2020/0313227, corresponding to U.S. patent application Ser. No. 16/830,285, which is incorporated herein by reference in its entirety.

### C. Amorphous Carbon Coating

The amorphous carbon coating is disposed at least partially on a surface of the first porous ceramic matrix of the anode. In some embodiments, the amorphous carbon coating is disposed at least partially on a surface of the ceramic separator layer. In other embodiments, the ceramic separator layer is substantially free of, or free of, the amorphous carbon coating.

In some embodiments, the amorphous carbon coating is electron conductive. In other embodiments, the amorphous carbon coating is ion conductive. And, in some embodiments, the amorphous carbon coating is electron conductive and ion conductive.

In some embodiments, the amorphous carbon coating is disposed at least partially on a surface of the first porous ceramic matrix in one or more pores.

In some embodiments, at least a portion of the amorphous carbon coating has a thickness of from about 1 nm to about 800 nm. In other embodiments, at least a portion of the amorphous carbon coating has a thickness of from about 150 nm to about 650 nm. In some embodiments, at least a portion of the amorphous carbon coating has a thickness of from about 250 nm to about 550 nm. In other embodiments, at least a portion of the amorphous carbon coating has a thickness of from about 300 nm to about 500 nm. In some embodiments, at least a portion of the amorphous carbon coating has a thickness of from about 350 nm to about 450 nm. And, in some embodiments, at least a portion of the amorphous carbon coating has a thickness of about 400 nm.

### D. Anode-Side Current Collector

The anode-side current collector is coupled to at least a portion of the first porous ceramic matrix. For example, the anode-side current collector may be coupled to a portion of the first porous ceramic matrix distal to the ceramic separator layer.

The anode-side current collector may comprise any suitable material for collecting current generated at the anode. In some embodiments, the anode-side current collector comprises stainless steel, copper, nickel, titanium, gold, carbon, or any combination thereof. In some embodiments, the anode-side current collector comprises stainless steel. In other embodiments, the anode-side current collector comprises copper. In some embodiments, the anode-side current collector comprises nickel. In some embodiments, the anode-side current collector comprises titanium. In other embodiments, the anode-side current collector comprises gold. And, in some embodiments, the anode-side current collector comprises carbon.

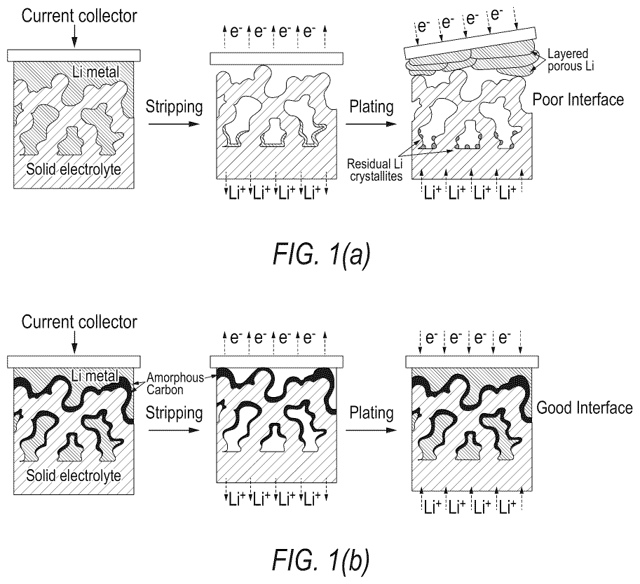

In some embodiments, the amorphous carbon coating has an affinity for an anode active material, as described herein. In some embodiments, the amorphous carbon coating may have a strong affinity for lithium (e.g., may be capable of trapping and containing lithium ions). Without wishing to be bound by theory, it is believed that the affinity of the amorphous carbon coating for the anode active material results in retention of residual anode active material on the anode as a continuous layer after stripping, instead of small, isolated crystallites. Thus, the amorphous carbon coating reduces the loss of conducting pathways and maintains connection between the anode and an anode-side current collector. In other words, a good interface between the anode and the anode-side current collector is maintained as compared to an anode assembly without the amorphous carbon coating (FIGS. 1(a) and (b)).

With reference to FIGS. 2(f)-2(h), in some embodiments, the amorphous carbon coating has a flake-stacked structure. Without wishing to be bound by theory, it is believed that the flake-stacked structure accommodates volume expansion of the of the amorphous carbon coating during lithiation and delithiation, thereby preventing or reducing detachment of the amorphous carbon coating from the anode upon cycling.

In some embodiments, the amorphous carbon coating is thicker at the portion of the surface of the first porous ceramic matrix coupled to the anode-side current collector than the surface of the first porous ceramic matrix in one or more pores.

### III. LITHIUM-ION BATTERY

In one aspect, the present invention provides a lithium-ion battery. The lithium-ion battery comprises an anode assembly, a cathode, and at least one of an anode active material and a cathode active material.

### A. Anode Assembly

The Anode assembly may be any anode assembly described herein. For example, in some embodiments, the anode assembly comprises an anode, a ceramic separator layer, an amorphous carbon coating, and an anode-side current collector. The anode may comprise a first porous ceramic matrix comprising a plurality of pores. The ceramic separator layer may be coupled to the anode. The amorphous carbon coating may be disposed on at least a portion of a surface of the first porous ceramic matrix. And, the anode-side current collector may be coupled to at least a portion of the first porous ceramic matrix.

### B. Cathode

The lithium-ion battery includes a cathode. The cathode may comprise any suitable material. Examples of cathode materials include, but are not limited to, conducting carbon materials, sulfur (S), oxygen (O₂), organic sulfide or polysulfide (e.g., carbynepolysulfide and copolymerized sulfur), and the like.

The cathode material can be an air electrode. Examples of materials suitable for air electrodes include those used in solid-state lithium-ion batteries with air cathodes such as large surface area carbon particles (e.g., Super P which is a conductive carbon black) and catalyst particles (e.g., alpha-MnO₂ nanorods) bound in a mesh (e.g., a polymer binder such as PVDF binder).

In some embodiments, the cathode comprises a second porous ceramic matrix having pores. In some embodiments, the second porous ceramic matrix is the same as the first porous ceramic matrix. In other embodiments, the second porous ceramic matrix is different from the first porous ceramic matrix. In some embodiments, the second porous ceramic matrix comprises a garnet material. Non-limiting examples of garnet materials include lithium garnet materials, doped lithium garnet materials, lithium garnet composite materials, and combinations thereof. Non-limiting examples of lithium garnet materials include Lia-phase lithium garnet SSE materials (e.g., Li₃M¹Te₂O₁₂, where M¹ is a lanthanide such as Y, Pr, Nd, Sm, Eu, Gd, Tb, Dy, Ho, Er, Tm, Yb, Lu, Zr, Ta, or a combination thereof and Li₃₊ₓNd₃Te₂₋ₓO₁₂, where x is 0.05 to 1.5; Li₅-phase lithium garnet SSE materials (e.g., Li₅La₃M₂²O₁₂, where M² is Nb, Zr, Ta, Sb, or a combination thereof, cation-substituted Li₅La₃M₂²O₁₂ such as, for example, Li₆M¹La₃M₂²O₁₂, where M¹ is Mg, Ca, Sr, Ba, or combinations thereof, and Li₇La₃M₂²O₁₂, where M² is Zr, Sn, or a combination thereof); Lib-phase lithium garnet SSE materials (e.g., Li₆M¹La₂M²₂O₁₂, where M¹ is Mg, Ca, Sr, Ba, or a combination thereof and M 2 is Nb, Ta, or a combination thereof); cation-doped Li₆La₂BaTa₂O₁₂; cation-doped Li₆BaY₂M²₂O₁₂, where M² is Nb, Ta, or a combination thereof and the cation dopants are barium, yttrium, zinc, or combinations thereof, an Li₇-phase lithium garnet SSE material (e.g., cubic Li₇La₃Zr₂O₁₂ and Li₇Y₃Zr₂O₁₂); cation-doped Li₇La₃Zr₂O₁₂; Li₅₊₂ₓLa₃, Ta₂₋ₓO₂, where x is 0.1 to 1, Li_{6.8}(La_{2.95},Ca_{0.5})(Zr_{1.75},Nb_{0.25})O₁₂ (LLCZN), Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂), lithium garnet composite materials (e.g., lithium garnet-conductive carbon matrix or composites with other materials). Other examples of lithium-ion-conducting SSE materials include cubic garnet-type materials such as 3 mol % YSZ-doped Li_{7.6}La₃Zr_{1.94}Y_{0.06}O₁₂ and 8 mol % YSZ-doped Li_{7.16}La₃Zr_{1.94}Y_{0.06}O₁₂. Additional examples of suitable Li-garnet SSE materials include, but are not limited to, Li₅La₃Nb₂O₁₂, Li₅La₃Ta₂₀₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}TaO₆O₁₂, Li_{6.5}La_{2.5}Ba_{0.5}TaZrO₁₂, Li_{7.16}Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂. In some embodiments, the garnet material is, for example, Li₇₋ₓLa_{3-y}M¹Zr_{2-z}M²_{z}O₁₂, wherein x greater than 0 and less than 2, M¹ is chosen from Ba, Ca, Y, and combinations thereof, and M 2 is chosen from Nb, Ta, and combinations thereof. In some embodiments, the garnet material is Li_{6.75}La₃Zr_{1.75}Ta_{0.25}O₁₂ (LLZT), Li_{6.75}La_{2.75}Zr_{1.75}Ca_{0.25}Nb_{0.25}O₁₂ (LLZCN), Li₅La₃Nb₂₀₁₂ (LLZNO), Li₇La₃Zr₂O₁₂ (LLZ), Li₅La₃Ta₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li_{6.75}BaLa₂Nb_{1.75}Zn_{0.25}O₁₂, Li_{6.75}BaLa₂Ta_{1.75}Zn_{0.25}O₁₂, or any combination thereof. In some embodiments, the garnet material is LLZT.

In some embodiments, the cathode has an apparent porosity of from about 20% to about 80%. In other embodiments, the cathode has an apparent porosity of from about 35% to about 75%. In some embodiments, the cathode has an apparent porosity of from about 45% to about 65%. And, in some embodiments, the cathode has an apparent porosity of from about 50% to about 60%.

In some embodiments, the cathode has a thickness of from about 1 μm to about 100 μm. In other embodiments, the cathode has a thickness of from about 20 μm to about 80 μm. In some embodiments, the cathode has a thickness of from about 30 μm to about 70 μm. And, in some embodiments, the cathode has a thickness of from about 50 μm to about 70 μm.

In some embodiments, the anode, the ceramic separator, and the cathode are a trilayer structure as described in United States Patent Application Publication No. 2020/0313227, corresponding to U.S. patent application Ser. No. 16/830,285, which is incorporated herein by reference in its entirety.

In some embodiments, the lithium-ion battery further comprises a carbon nanotube coating disposed at least partially on the cathode (e.g., at least partially on a surface the second porous ceramic matrix).

In some embodiments, the lithium-ion battery further comprises a cathode-side current collector coupled to at least a portion of the cathode (e.g., at least a portion of the second porous ceramic matrix). The cathode-side current collector collects current generated at the cathode. When present, the cathode-side current collector may comprise any suitable material for collecting current generated at the cathode. In some embodiments, the cathode-side current collector comprises stainless steel, copper, nickel, titanium, gold, carbon, or any combination thereof. In some embodiments, the cathode-side current collector comprises stainless steel.

### C. Active Materials

The lithium-ion battery comprises at least one of an anode active material and a cathode active material. In some embodiments, the lithium-ion battery comprises an anode active material. In other embodiments, the lithium-ion battery comprises a cathode active material. And, in some embodiments, the lithium-ion battery comprises an anode active material and a cathode active material.

The anode active material is disposed in the pores of the anode. The anode active material comprises lithium. For example, the anode active material may be lithium metal or a lithium alloy. In some embodiments, the anode active material is lithium metal. In some embodiments, the anode active material may comprise carbon compound (e.g. graphite, carbon nanotubes, etc.), silicon containing compounds, sodium metal, sodium containing compounds, or any combination thereof.

In some embodiments, the anode active material has a nucleation overpotential of from about 0.1 mV to about 5 mV at 0.5 mA/cm². In other embodiments, the anode active material has a nucleation overpotential of from about 0.25 mV to about 2.5 mV at 0.5 mA/cm². In some embodiments, the anode active material has a nucleation overpotential of from about 0.5 mV to about 1.5 mV at 0.5 mA/cm². And, in some embodiments, the anode active material has a nucleation overpotential of about 1.0 mV at 0.5 mA/cm².

In some embodiments, the anode active material after infiltration of the anode has a morphology substantially free of sharp edges after infiltration. Without wishing to be bound by theory, it is believed that the anode active material presents a sharp edge morphology after infiltration of anode assemblies without amorphous carbon coatings due to its ductility during plastic deformation. Thus, the amorphous carbon coating advantageously allows infiltration of the anode active material with a morphology substantially free of sharp edges.

The cathode active material is disposed in the cathode. The cathode active material may comprise any suitable material. For example, the cathode active material may comprise to lithium compound cathode materials (e.g. LiCoO₂, LiMnO₂, LiNiₓMn_{y}Co_{z}O₂, LiFePO₄, etc.), sulfur-based cathode materials (e.g. S, LixS), oxygen, or air cathodes. In some embodiments, the cathode active material comprises lithium. In some embodiments, the cathode active material comprises sulfur. For example, the cathode active material may comprise Li₂S₈. In other examples, the cathode active material comprises NCA, NMC, LFP, spinel-type cathode material, or any combination thereof.

### D. Alternative Embodiments

In one aspect, the present invention provides a lithium-ion battery comprising:
an anode assembly comprising,
   an anode comprising a first porous ceramic matrix having pores,
   a ceramic separator layer coupled to the anode, and
   an amorphous carbon coating disposed at least partially on a surface of the first porous ceramic matrix, wherein the ceramic separator layer is substantially free of the amorphous carbon coating;
   an anode-side current collector coupled to at least a portion of the first porous ceramic matrix;
a cathode; and
at least one of:
   an anode active material disposed in the pores of the anode, wherein the anode active material comprises lithium, and
   a cathode active material disposed in the cathode.

In another aspect, the present invention provides a lithium-ion battery comprising:
an anode assembly comprising,
   an anode comprising a first porous ceramic matrix having pores,
   a ceramic separator layer coupled to the anode, and
   an amorphous carbon coating disposed at least partially on a surface of the first porous ceramic matrix, wherein the amorphous carbon coating has a flake-stacked structure, and wherein at least a portion of the amorphous carbon coating has a thickness of from about 250 nm to about 550 nm;
   an anode-side current collector coupled to at least a portion of the first porous ceramic matrix;
a cathode; and
at least one of:
   an anode active material disposed in the pores of the anode, wherein the anode active material comprises lithium, and
   a cathode active material disposed in the cathode.

In yet another aspect, the present invention provides a lithium-ion battery comprising:
an anode assembly comprising,
   an anode comprising a first porous ceramic matrix having pores,
   a ceramic separator layer coupled to the anode, and
   an amorphous carbon coating disposed at least partially on a surface of the ceramic separator layer;
   an anode-side current collector coupled to at least a portion of the first porous ceramic matrix;
a cathode;
a cathode-side current collector coupled to at least a portion of the cathode;
an anode active material disposed in the pores of the anode, wherein the anode active material comprises lithium, and a cathode active material disposed in the cathode.

In yet another aspect, the present invention provides a lithium-ion battery comprising:
an anode assembly comprising,
   an anode comprising a first porous ceramic matrix having pores,
   a ceramic separator layer coupled to the anode, and
   an amorphous carbon coating disposed at least partially on a surface of the first porous ceramic matrix;
   an anode-side current collector coupled to at least a portion of the first porous ceramic matrix;
a cathode;
a cathode-side current collector coupled to at least a portion of the cathode;
an anode active material disposed in the pores of the anode, wherein the anode active material comprises lithium, and a cathode active material disposed in the cathode.

### IV. METHODS OF FORMING AN ANODE ASSEMBLY

In another aspect, the present invention provides a method of forming an anode assembly for a lithium-ion battery, comprising:
(a) providing an anode and a ceramic separator layer coupled to the anode, wherein the anode comprises a porous ceramic matrix having pores; and
(b) disposing an amorphous carbon coating at least partially on a surface of the porous ceramic matrix to form the anode assembly.

The anode may be any anode described herein. The ceramic separator layer may be any separator described herein.

In some implementations, step (b) comprises disposing an amorphous carbon coating at least partially on the surface of the porous ceramic matrix in a vacuum chamber.

In some implementations, step (b) comprises disposing the amorphous carbon coating at least partially on the surface of the porous ceramic matrix at a temperature less than about 50° C. For example, step (b) comprises disposing the amorphous carbon coating at least partially on the surface of the porous ceramic matrix at room temperature.

The amorphous carbon coating may be disposed at least partially on the surface of the porous ceramic matrix via any suitable deposition process. For example, the amorphous carbon coating may be disposed at least partially on the surface of the porous ceramic matrix via physical vapor deposition (PVD) or chemical vapor deposition (CVD). In some implementations, step (b) comprises disposing an amorphous carbon coating at least partially on the surface of the porous ceramic matrix via physical vapor deposition. And in some implementations, step (b) comprises disposing an amorphous carbon coating at least partially on the surface of the porous ceramic matrix via a sputtering device.

When the sputtering device is used for deposition of the amorphous carbon coating, the sputtering device may comprise a carbon source. In some implementations, the carbon source is a graphite rod. In some implementations, a distance between the carbon source and the porous ceramic matrix is at least about 10 mm (e.g., at least about 15 mm). In other implementations, a distance between the carbon source and the porous ceramic matrix is less than about 25 mm (e.g., less than about 20 mm).

In some implementations, the method further comprises
(c) masking at least a portion of the ceramic separator layer prior to step (b).

In some implementations, step (c) comprises masking at least about 5%, at least about 10%, at least about 20%, at least about 30%, at least about 40%, at least about 50%, at least about 60%, at least about 70%, at least about 80%, at least about 90%, or about 100% of the ceramic separator layer prior to step (b).

The amorphous carbon coating may be any amorphous carbon coating as described herein. In some implementations, the amorphous carbon coating is electron conductive. In some implementations, the amorphous carbon coating is ion conductive. And, in some implementations, the amorphous carbon coating is electron conductive and ion conductive.

In some implementations, the amorphous carbon coating is disposed at least partially on the surface of the porous ceramic matrix in one or more pores.

In some implementations, at least a portion of the amorphous carbon coating has a thickness of from about 1 nm to about 800 nm. In other implementations, at least a portion of the amorphous carbon coating has a thickness of from about 150 nm to about 650 nm. And in some implementations, at least a portion of the amorphous carbon coating has a thickness of from about 250 nm to about 550 nm. In other implementations, at least a portion of the amorphous carbon coating has a thickness of from about 300 nm to about 500 nm. In some implementations, at least a portion of the amorphous carbon coating has a thickness of from about 350 nm to about 450 nm. And, in some implementations, at least a portion of the amorphous carbon coating has a thickness of about 400 nm.

In some implementations, the amorphous carbon coating has a flake-stacked structure. In some implementations, the method further comprises
(d) setting the amorphous carbon coating in a dry environment after step (b).

In some implementations, the method further comprises
(e) coupling an anode-side current collector to at least a portion of the porous ceramic matrix after step (b).

The anode-side current collector may be any anode-side current collector as described herein. In some implementations, the anode-side current collector comprises stainless steel, copper, nickel, titanium, gold, carbon, or any combination thereof. In some implementations, the anode-side current collector comprises stainless steel.

In one aspect, the present invention provides a method of forming an anode assembly for a lithium-ion battery, comprising:
(a-1) providing an anode and a ceramic separator layer coupled to the anode, wherein the anode comprises a porous ceramic matrix having pores;
(b-1) disposing an amorphous carbon coating at least partially on a surface of the porous ceramic matrix to form the anode assembly; and
(c-1) masking at least a portion of the ceramic separator layer prior to step (b).

In another aspect, the present invention provides a method of forming an anode assembly for a lithium-ion battery, comprising:
(a-2) providing an anode and a ceramic separator layer coupled to the anode, wherein the anode comprises a porous ceramic matrix having pores;
(b-2) disposing an amorphous carbon coating at least partially on a surface of the porous ceramic matrix;
(c-2) masking at least a portion of the ceramic separator layer prior to step (b); and
(e-2) coupling an anode-side current collector to at least a portion of the porous ceramic matrix after step (b) to form the anode assembly.

Disclosed herein are batteries and battery components with solid-state electrolytes, such as ceramic Li-ion conductors, which can inhibit the formation of Li dendrites and reduce the likelihood of short-circuiting, and can have improved flammability and leak characteristics. Also disclosed are embodiments with improved or more stable contact between solid-state electrolytes and anode active materials, such as a Li metal anode, and embodiments that can reduce the change of volume of portions of the battery or battery system, such as the anode, during battery cycling. In some embodiments, improvements related to interface contact and reduction in volume change of battery components during cycling can also broaden the applicable capacity of the Li metal anodes with planar solid-state electrolytes.

The present invention includes embodiments related to a 3D ionic conductive host for Li metal anodes. In an example embodiment, the 3D ionic conductive host includes a 3D garnet-type Li-ion conductor with a porous-dense-porous trilayer (or porous-dense bilayer) structure as the Li host and a current collector (such as a coated electronic conductive layer). The trilayer (or bilayer) garnet framework can in some embodiments be fabricated by a tape-casting method and can in some embodiments be co-sintered into a combined structure. The current collector can be affixed (such as by coating) to a side of the framework by any suitable means and in particular embodiments, can be formed or adhered by e-beam evaporation or other physical vapor deposition methods or by other means of affixing or forming the current collector such that electrical conductivity occurs between the framework and the current collector. In some embodiments, Li metal anode can be filled in the porous garnet host as the anode active material by melt-infiltration method or electrochemical deposition. In some embodiments, the active material can be added to the battery as a part of a cathode, and then electroplated into the porous anode by cycling of the battery. In some embodiments, such as for a symmetric cell, the active material can be added to the region to one side of the separator and then electroplated to the other side of the separator as a Li metal. In some embodiments, cathode materials can be added directly to the region that will serve as a the cathode of the battery or battery system.

Also disclosed herein is a 3D anode frame work based on a mixed electron/ion conducting framework. The 3D anode frame work was achieved by conformal coating of an electrically conducting material that is compatible with the anode active material, such as coating a carbon material on porous garnet structure for a lithium metal anode material, which was then used as the 3D lithium host. Li was introduced into the 3D host via electrochemical deposition (or electroplating), which leads to improved coating of the lithium anode material on the garnet electrolyte material, resulting in a low resistance which in some embodiments was 25 Ωcm². With the trilayer structure (or a bilayer structure combined with a cathode which can optionally comprise a liquid), the Li can be cycled between the 3D anode framework and the cathode infused into the cathode porous structure during battery operation (such as one or more charge and/or discharge cycles.) With the same local current density, the surface area of the porous garnet framework can result in higher overall current density with stable lithium deposition. A current density of 1 mA/cm² demonstrated with stable Li cycling during operation of the battery.

In some embodiments of a battery or a battery system, the amorphous carbon coating can extend from the anode-side current collector into the first porous ceramic matrix of the anode. In some embodiments, the amorphous carbon coating may extend only part-way toward the ceramic separator layer, or all of the way to the ceramic separator layer. In some embodiments, the amorphous carbon coating forms an electrically conductive path into the first porous ceramic matrix of the anode. Without wishing to be bound by theory, it is believed that during a cycle where the anode active material (such as lithium metal) is plated into pores of the first porous ceramic matrix of the anode, the specific locations where plating occurs can be where the electrons and the anode active material are combined. Areas of the first porous ceramic matrix of the anode that have the amorphous carbon coating electrically connected to the anode-side current collector may preferentially plate anode active material.

In systems where the amorphous carbon coating is present on the surface of the pores of the anode (i.e., the surface of the pores of the first porous ceramic matrix), the anode active material may plate preferentially on areas having an electrical connection to the anode-side current collector. In systems where the amorphous carbon coating is present on the surface of the pores of the anode and extends to the ceramic separator layer, the anode active material may plate on and/or adjacent to the ceramic separator layer early in the charging cycle. Plating on and/or adjacent to the ceramic separator layer can lead to increased risk of dendrite formation due to the growth plating in proximity to the ceramic separator layer and favorable conditions for continued deposition, such as ion concentration gradients and low electrical resistance.

In systems where the amorphous carbon coating is present on the surface of the pores of the anode, but the amorphous carbon coating does not extend to the ceramic separator layer (for example, there is a gap or a band where the amorphous carbon coating does not extend to), then the anode active material may plate along the amorphous carbon coating and would not favor growing further toward the ceramic separator layer, thus disfavoring dendrite formation. In some embodiments, it can also be favorable to control the current during charging of the cell in order to also disfavor plating progressing toward the ceramic separator layer. In addition, as explained above, the plated anode active material can also act as an electrical conductor and again, without wishing to be bound by theory, it is believed that under battery cycling conditions, discharging of a cell/battery does not completely remove the anode active material from the anode, but it is believed that a small amount of anode active material can be left behind, leading to increased electrical conductivity. Accordingly, it is desirable that when the anode active material is initially loaded into a battery or cell, the anode active material does not reach the ceramic separator layer.

Various methods can be used to charge the anode active material and to coat the pores of the anode with the amorphous carbon coating to selectively fill the ceramic separator layer with anode active material and/or deposit the amorphous carbon coating on the ceramic separator layer, or to leave a region of unfilled/uncoated anode proximal to the ceramic separator layer. Filling methods can include deposition techniques, liquid techniques (e.g. dissolving or suspending the active material or an active material precursor in a liquid such as a solvent or another liquid, presenting the liquid with material to the porous material, followed by conversion of material precursor), or presenting melted anode active material to the surface of the anode, or by charging the anode active material to the opposite side of the battery/cell (such as the cathode or the other side of the symmetric cell) followed by electroplating the anode active material to the anode. Degree of penetration can be controlled by techniques such as selection of the deposition technique, timing of the liquid contact, pretreating with a liquid to partially fill the pores prior to applying the liquid with material, application of pressure or vacuum, etc.

Coating methods can also include such methods as deposition techniques, liquid techniques (e.g. dissolving or suspending the active material or an active material precursor in a liquid such as a solvent or another liquid, presenting the liquid with material to the porous material, followed by conversion of material precursor), etc. Degree of penetration of the coating can also be controlled by techniques such as selection of the deposition technique, timing of the liquid contact, pretreating with a liquid to partially fill the pores prior to applying the liquid with material, application of pressure or vacuum, etc.

In some embodiments, combinations of methods for filling or coating can be used. And, in some embodiments, a portion of the active material (e.g., anode active material and/or cathode active material) can be added directly to the first porous ceramic matrix of the anode and a portion can be added by electroplating from the cathode. In some embodiments, it can be desirable for the capacity of the anode to be greater than the capacity of the cathode in order to prevent overfilling the anode with active material. In some embodiments of a symmetric cell, the capacity of a side with partial electrically conducting coated pores be greater than the capacity of the other side to prevent overfilling of the side with the partial coating.

In various embodiments, batteries and cell systems and components disclosed herein offer:
high-capacity and/or improved-safety for anodes in solid-state and hybrid battery architectures;
improved interfacial contact and reduced dendrite penetration risk of anodes; and
solid-state lithium-ion batteries (e.g. Li-sulfur batteries and Li-air batteries) having higher energy density and improved safety.

### V. EXAMPLES

### Material Characterization

SEM images were captured with a Tescan XEIA FEG SEM. Raman spectrum was obtained with a Yvon Jobin LabRam ARAMIS. The XRD patterns were obtained using a D8 Bruker Advanced X-ray Diffraction system.

### Example 1: Fabrication of Anode Assemblies

### Synthesis of Garnet Powder

Li_{6.75}La₃Zr_{1.75}Ta_{0.25}O₁₂ (LLZT) powder was synthesized via a solid-state reaction method. Li₀H·H₂O (99.9%, Sigma Aldrich), La₂O₃ (>99.9%, Sigma Aldrich), ZrO₂ (99.9%, Sigma Aldrich), and Ta₂O₅ (99.9%, Sigma Aldrich) were stoichiometrically mixed in isopropyl alcohol (IPA) and ball-milled for 12 hours (h). A 10% excess of Li₀H·H₂O was employed to compensate for loss of lithium during the reaction. The stoichiometrically mixed powders were calcined at 920° C. for 12 h in air. Then, the powders were mixed with IPA and ball-milled for 9 h. The IPA was evaporated at 120° C. to afford LLZT powder.

Fabrication of Anode Assembly

The LLZT (30 wt %) powder, fish oil (0.5 wt %), isopropanol (21 wt %), and toluene (21 wt %) were weighed into a jar with yttria-stabilized zirconia grinding spheres and ball-milled for 24 h. Benzyl butyl phthalate (BBP, 6.5 wt %) and polyvinyl butyral (PVB, 5.0 wt %) were added and milled for another 24 h. After the ball milling process, 10 μm cross-linked PMMA spheres (16 wt %) were added as porogens. The resultant slurry was further milled for 1 h, then degassed under 25 inHg vacuum for 3 h. Slurries were cast at 10 cm/min through a doctor blade onto a mylar sheet. The tapes were then laminated together by pressing at 170 psi and 60° C. for 15 min to form multilayer structures. Samples (1.3 cm) were cut from the laminated tapes and sintered at 1050° C. for 1 h.

FIG. 2(a) shows trilayer structures formed from the above samples. The resultant porous layer (i.e., anode/cathode) had a thickness of about 60 μm. The resultant dense layer (i.e., ceramic separator layer) had a thickness of about 30 μm. The porous layer (i.e., anode/cathode) had an apparent porosity of 54.1±2.6%, which was suitable for filling with active electrode.

Fabrication of Anode Assembly Comprising an Amorphous Carbon Coating

Deposition of the amorphous carbon coating on samples of the anode assemblies above was achieved with an Agar sputter coater. A piece of graphite rod was employed as the carbon source. A premade mask was covered on top of the samples of the anode assemblies to limit the deposition regions. The deposition process was carried out in the vacuum chamber at room temperature. The distance between the samples of the anode assemblies and the carbon source was 15 mm. 30-time high current pulse was applied for growth of the amorphous carbon coating. Resultant samples were set in a dry environment to avoid the formation of Li₂CO₃.

FIG. 2(b) is a schematic showing the deposition and thickness distribution of the amorphous carbon coating. The high porosity and large pores of the anode facilitated direct deposition of the amorphous carbon coating without the use of any organic solvents that may form contamination layers. The amorphous carbon coating at regions where the anode contacts with the anode-side current collector was thicker (around 300-400 nm, FIG. 2(i)) than at regions inside the pores. The inset image in FIG. 2(b) shows a top view of the anode assembly after carbon coating deposition with regional masked confinement to avoid cell shorting induced by carbon overdeposition across the edge. As shown in FIG. 2(c), X-ray diffraction (XRD) patterns of the anode with and without the amorphous carbon coating present well crystalline structures, the peaks of which are consistent with the cubic-phase garnet in the database (International Center for Diffraction Data: 80-0457). No new peaks were observed after the deposition of the amorphous carbon coating, thus confirming the amorphous state of the carbon coating and good stability between the amorphous carbon coating and the anode in a dry environment. FIG. 2(d), is a SEM image of the anode morphology after amorphous carbon deposition. The inset image displays a Raman spectra of the as-deposited amorphous carbon coating. The strong D1 peak at around 1343 cm⁻¹ further corroborates the amorphous state of the carbon coating. FIGS. 2(e) and 2(f) show a comparison of the anode morphology changes without and with the amorphous carbon coating. Compared to the smooth surface of the anode without the amorphous carbon coating, the anode with the amorphous carbon coating demonstrates a pronounced rough flake-stacked structure, with small intervals between flakes (FIGS. 2(g) and 2(h)).

### Example 2: Li Metal Infiltration

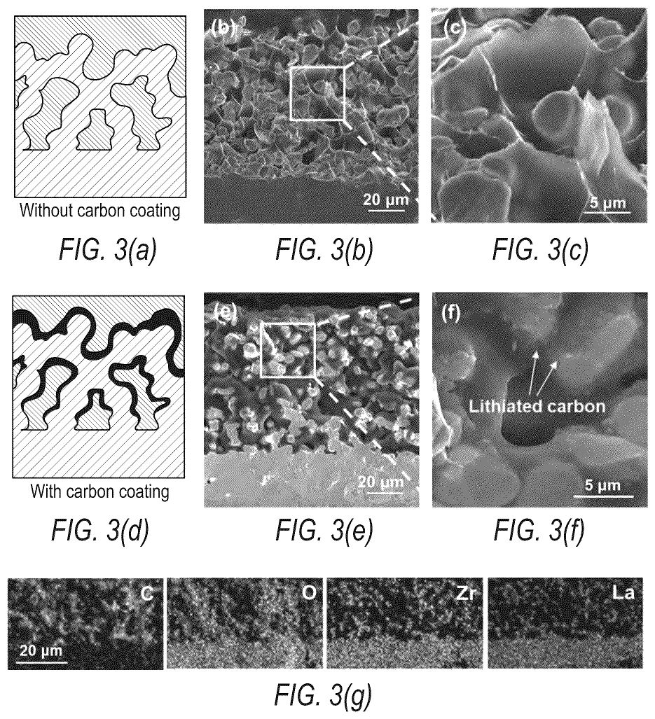

As shown schematically in FIGS. 3(a) and 3(d), lithium metal was heated above its melting temperature (to about 200° C.) and infiltrated into the pores of anodes with and without the amorphous carbon coating. With reference to FIGS. 3(b) and 3(c), a sharp edge morphology was obtained in the anode without the amorphous carbon coating. This sharp edge morphology was attributed to the ductility of lithium metal during plastic deformation. In contrast, the morphology of lithium metal in the anode with the amorphous carbon coating showed no obvious sharp edges (FIGS. 3(e) and 3(f)). This absence of sharp edges was attributed to lithium metal fixation by the amorphous carbon coating via lithiation. As shown in FIG. 3(g), energy-dispersive X-ray spectroscopy (EDS) mapping indicated that the amorphous carbon coating was well dispersed, with strong EDS signals in the pores of the anodes indicative of good permeation during deposition.

### Example 3: Lithium Plating/Stripping Test

The role of the amorphous carbon coating on homogenizing the lithium metal stripping/plating behavior was investigated to characterize the morphology change of Li metal in the anode assembly.

Fabrication of Lithium Half Cells

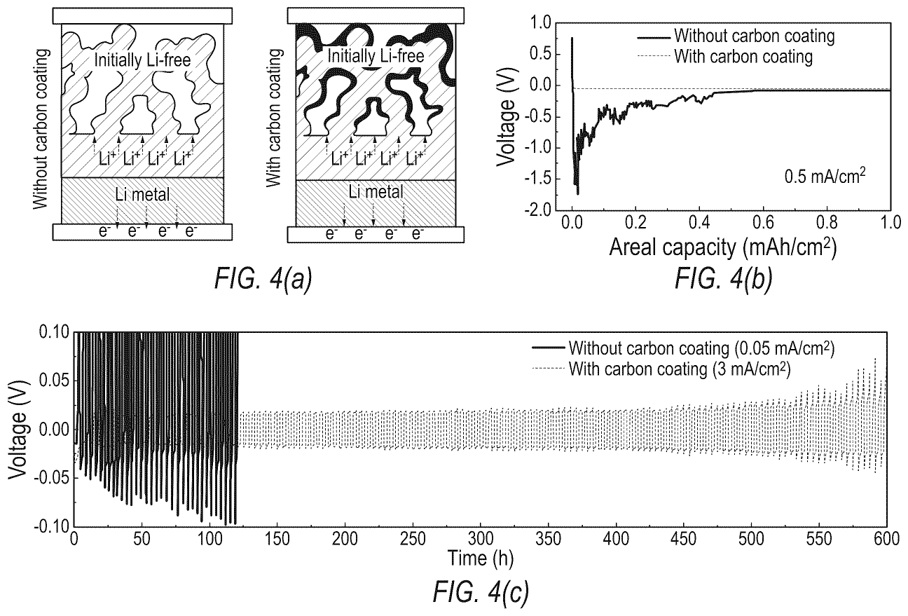

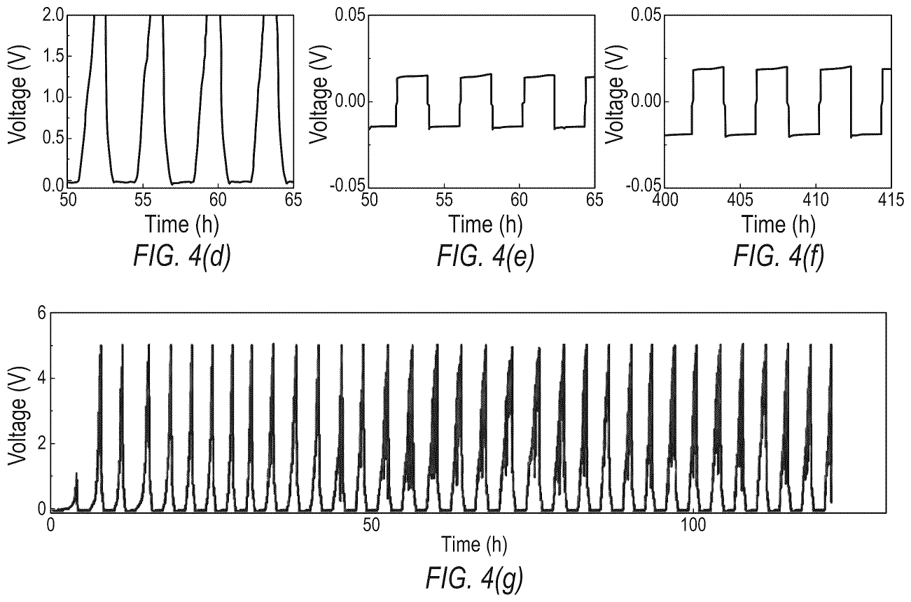

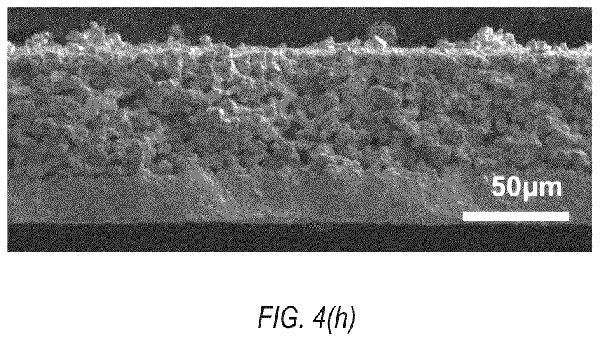

A porous-dense (i.e., anode-ceramic separator layer) structure, as shown in FIG. 4(h), was employed as both the electrolyte and backbone of the half cell. The amorphous carbon coating was deposited in the porous structure to provide both electronic and ionic conductivity. Li metal was melted at a temperature above 200° C. to deposit on the dense side of the porous-dense structure. Stainless steel current collectors were attached to both the lithium metal side and the porous side, as shown in FIG. 4(a).

Electrochemical Test

The electrochemical test was performed with a BioLogic battery testing system. A capacity-controlled scheme was employed for the test. The symmetric Lithium cell was cycled under a current density of 0.05 mA/cm² (without the amorphous carbon coating) and 3 mA/cm² (with the amorphous carbon coating) for a period of 4 h (i.e., a single stripping or plating step duration was 2 h (4 h per cycle)). The electrochemical impedance spectroscopy (EIS) was conducted on the BioLogic battery testing system with a voltage amplitude of 20 mV in the frequency range of 1 MHz-1 Hz.

As shown in FIG. 4(a), an external voltage was applied to strip Li metal from the dense side into the lithium-free porous side, and continuous stripping/plating cycles were carried out afterward to obtain voltage profiles. As shown in FIG. 4(b). lithium deposition profiles were characterized for the anode assemblies with and without the amorphous carbon coating, with areal current densities of 0.5 mA/cm². The deposition of Li metal on the anode without the carbon coating resulted in an obvious Li metal nucleation potential (the voltage dip at the very initial stage) of about 1.5 V at 0.5 mA/cm². This was attributed to the poor interface between the anode-side current collector and the anode. In contrast, the nucleation overpotential of the anode with the amorphous carbon coating resulted in a reduction (˜1 mV at 0.5 mA/cm²). This reduction was attributed to the affinity of the amorphous carbon coating for lithium metal.

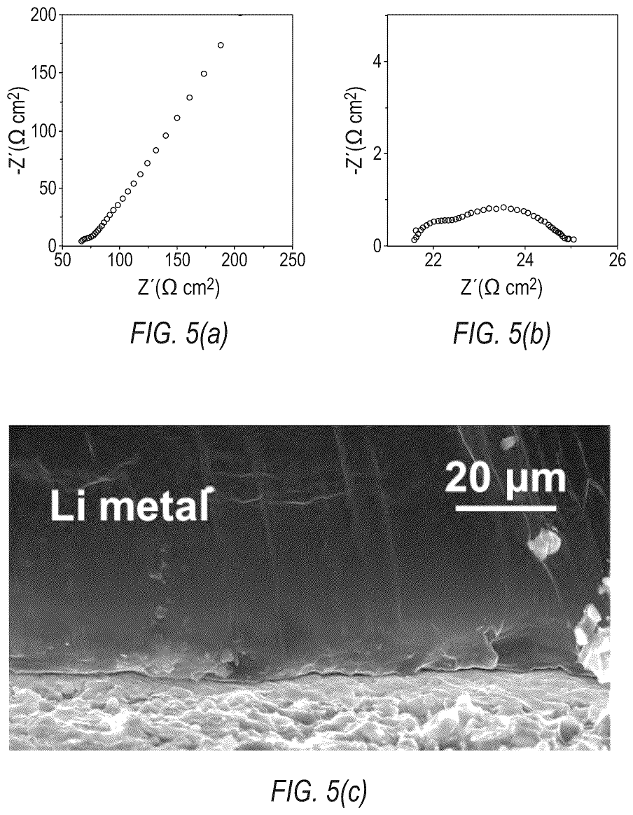

FIGS. 4(c) and 4(g) show the Li|electrolyte|Li-free initial structure cycling voltage profiles with plating and stripping of 4 h for each cycle to enable the direct comparison with and without the amorphous carbon coating. As set forth above, the cycling without the amorphous carbon coating was set at 0.05 mA/cm², whereas the anode assembly with the amorphous carbon coating was elevated to 3 mA/cm². The cycling profile of the anode assembly with the amorphous carbon coating demonstrated superior cycling stability for more than 500 h, as compared to the anode assembly without the amorphous carbon coating. FIGS. 4(d), 4(e), and 4(f), show local voltage profiles of the anode assemblies without and with the amorphous carbon coating. A high overpotential was observed for the anode assembly without the amorphous carbon coating during cycling due to the high interfacial resistance between the anode-side current collector and the anode. The overpotential for the anode assembly without the amorphous carbon coating exhibited asymmetric cycling, with stripping from the porous side significantly higher than that of plating. This indicates that higher resistance exists for the lithium metal to go back from the porous side to the dense side due to the poor interface. The anode in the anode assembly with the amorphous carbon coating exhibited a more symmetric plating/stripping voltage and maintains stable cycling. EIS profiles for the anode assembly with the amorphous carbon coating before and after cycling are shown in FIGS. 5(a) and 5(b). As lithium metal was initially only melted on the dense layer side before the cycling, the impedance of the cell was high with a Warburg diffusion tail. After the cycling, the Warburg tail vanished, and the impedance presented a significant decrease due to the interface amelioration. Cycling of the anode assembly with the amorphous carbon coating after 500 h presented a gradual increase in overpotential, which was attributed to the interface degradation between the dense garnet layer and the lithium metal. This degradation is observable in the SEM image of FIG. 5(c).

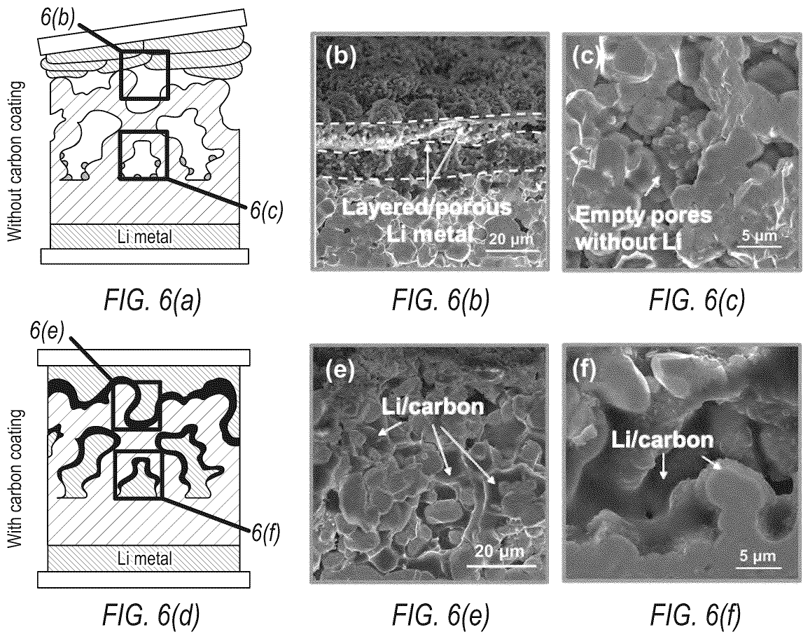

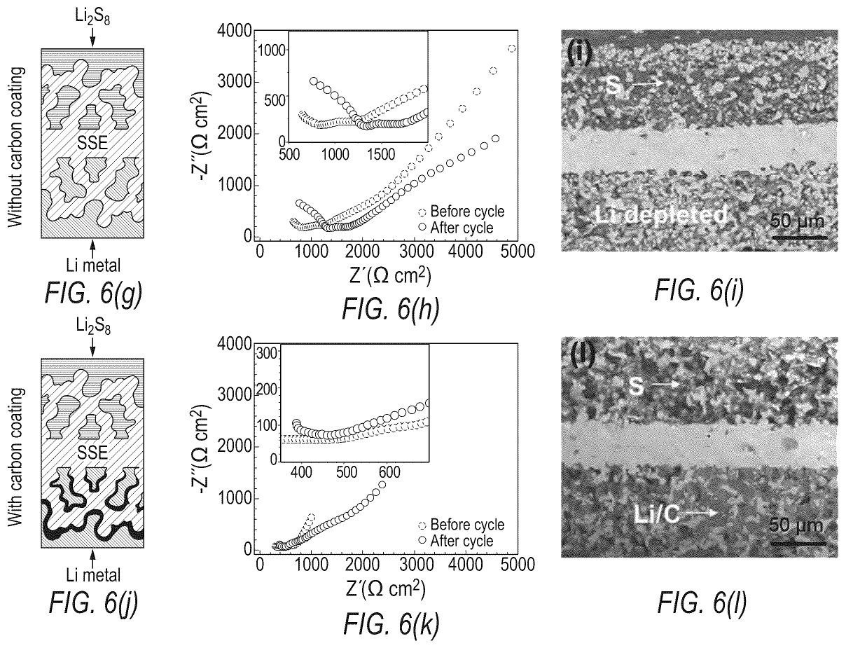

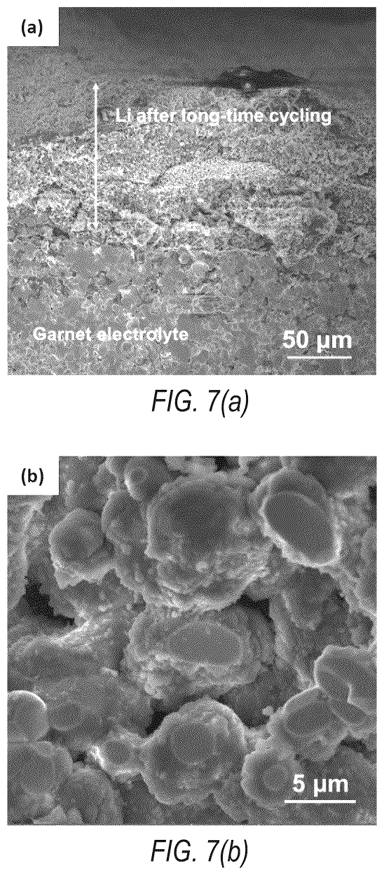

With reference to FIGS. 6(b) and 6(c), SEM images of the lithium metal distribution and morphology on the anode assembly without the amorphous carbon coating are provided at regions shown schematically in FIG. 6(a). Lithium metal at the top surface tended to be layered and porous after long-term cycling, as the local high current density induced uneven growth and interfacial resistance halted lithium transport (FIG. 7(a)). At the same time, porous regions of the anode were empty of lithium metal due to a lack of availability of electrons from the current collector during plating. As a result, Li ions were not reduced directly inside these pores, thus failing to refill with Li metal.

In contrast, for the anode assembly with the amorphous carbon coating, lithium metal was directly observed in both regions of the anode (FIGS. 5(e) and 5(f)). The amorphous carbon coating homogenized electron transport, thus offering distributed sites for reduction of Li ions (FIG. 7(b)). The uniform deposition of lithium metal due to the amorphous carbon coating further contributes to electro-chemomechanically stable interfaces and cycling voltage profiles.

### Example 4: Comparison of Solid State Li—S Batteries

Fabrication of Solid-State Li—S Batteries

A porous-dense-porous structure garnet (trilayer) was used as the solid ion-conducting host for the Li metal anode and S cathode. The anode side was deposited with an amorphous carbon coating and filled with Li as described above. For the control, Li-filled trilayer garnet without the amorphous carbon coating was used as the anode. Then the cathode side of the trilayer garnet was coated with a thin layer of carbon nanotube (CNT) by drop-casting CNT-dimethylformamide (DMF) solution (1 mg CNT in 1 mL DMF). After evaporating the DMF at 100° C., 10 μL of Li₂S₈ solution (dissolved in TEGDME, equivalent S concentration 0.1 g/mL) was added into the pores of the cathode layer (0.5 cm²), followed by further evaporating the TEGDME solvent at 100° C. overnight in the glovebox. To improve the S cathode wetting and ion conducting, 2 μL of liquid electrolyte, which is 1 M lithium bis(trifluoromethanesulfonyl)imide) dissolved in dioxolane/1,2-dimethoxyethane (1/1, v/v), was added in the cathode side of the garnet host. Finally, the trilayer garnet with Li metal anode (with or without the amorphous carbon coating) and S cathode was sealed in a coin cell as the solid-state Li—S battery.

Electrochemical Test

The galvanostatic discharge/charge cycling of solid-state Li—S batteries was performed on Arbin electrochemical testing system at 0.05 C in the voltage range of 1.4-3.0 V at 60° C.

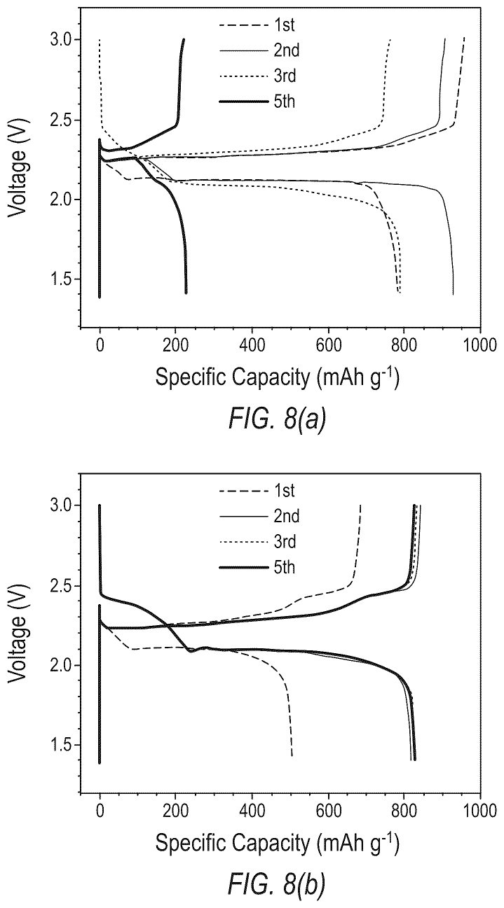

To demonstrate that the electro-chemomechanically stable anode assembly with the amorphous carbon coating advantageously benefits stability of full cells, solid-state Li—S batteries were prepared as described above (FIGS. 5(g), 5(j), 8(a) and 8(b)). The resultant Li—S batteries were cycled at room temperature. With reference to FIG. 5(h), EIS of the Li—S battery without the amorphous carbon coating before and after cycles showed that the impedance of the cm², leading to the failure of the solid-state Li—S battery. Post-mortem SEM analysis (FIG. of the Li—S battery without the amorphous carbon coating after cycling shows that Li metal, which was supposed to be in the pores of the anode was depleted. Without the amorphous carbon coating on the anode to help the Li-ion reduction, the Li metal anode of the solid-state Li—S battery was not reversibly plated in the trilayer garnet but was depleted after cycling. The Li depletion in the anode side results in an increase of the high-frequency region (FIG. 5(h)) of the impedance.

In comparison, the interface resistance of the Li anode with the amorphous carbon coating (the high frequency region in EIS) changed very little after cycling, as shown in FIG. approximately 420 Ωcm². SEM analysis (FIG. 5(i)) shows that the S cathode and the Li/C anode maintain their original state, without Li depletion from the trilayer garnet framework. Thus, the amorphous carbon coating in the garnet framework is critical to direct Li deposition in the full-cell cycling (FIG. 5(l)).

With reference to FIG. 8(a), galvanostatic discharge/charge voltage profiles at 0.05 C at ° C. for the lithium-ion battery without the amorphous carbon coating are shown. The initial two cycles exhibited a good discharge capacity of ˜800 mA h g⁻¹ (based on the mass of S), whereas in the subsequent cycles, the capacity declined to only 240 mA h g⁻¹ in the 5th cycle. With reference to FIG. 8(b), galvanostatic discharge/charge voltage profiles at 0.05 C at 60° C. for the lithium-ion battery with the amorphous carbon coating are shown. After the conversion from Li₂S₈ to Li₂S in the first discharge, the solid-state Li—S battery exhibited a stable discharge/charge capacity of >800 mA h g⁻¹ (based on the mass of S) with the typical two-plateau reaction for Li—S batteries.

### EQUIVALENTS AND SCOPE

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, the invention encompasses all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. It should it be understood that, in general, where the invention, or aspects of the invention, is/are referred to as comprising particular elements and/or features, certain embodiments of the invention or aspects of the invention consist, or consist essentially of, such elements and/or features. For purposes of simplicity, those embodiments have not been specifically set forth in haec verba herein. It is also noted that the terms “comprising” and “containing” are intended to be open and permits the inclusion of additional elements or steps. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

This application refers to various issued patents, published patent applications, journal articles, and other publications, all of which are incorporated herein by reference. If there is a conflict between any of the incorporated references and the instant specification, the specification shall control. In addition, any particular embodiment of the present invention that falls within the prior art may be explicitly excluded from any one or more of the claims. Because such embodiments are deemed to be known to one of ordinary skill in the art, they may be excluded even if the exclusion is not set forth explicitly herein. Any particular embodiment of the invention can be excluded from any claim, for any reason, whether or not related to the existence of prior art.

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

What is claimed is:

1. An anode assembly, comprising:
an anode comprising a first porous ceramic matrix comprising a plurality of pores;
a ceramic separator layer coupled to the anode; and
an amorphous carbon coating disposed on at least a portion of a surface of the first porous ceramic matrix.

2. The anode assembly of claim 1, wherein the anode assembly further comprises an anode-side current collector coupled to at least a portion of the first porous ceramic matrix

3. The anode assembly of claim 1, wherein the ceramic separator layer is substantially free of the amorphous carbon coating.

4. The anode assembly of claim 1, wherein the amorphous carbon coating is electron conductive.

5. The anode assembly of claim 4, wherein the amorphous carbon coating is ion conductive.

6. The anode assembly of claim 1, wherein the amorphous carbon coating is disposed at least partially on the surface of the first porous ceramic matrix in one or more pores.

7. The anode assembly of claim 1, wherein at least a portion of the amorphous carbon coating has a thickness of from about 1 nm to about 800 nm.

8. The anode assembly of claim 7, wherein at least a portion of the amorphous carbon coating has a thickness of from about 150 nm to about 650 nm.

9. The anode assembly of claim 8, wherein at least a portion of the amorphous carbon coating has a thickness of from about 250 nm to about 550 nm.

10. The anode assembly of claim 1, wherein the amorphous carbon coating has an affinity for an anode active material.

11. The anode assembly of claim 1, wherein the amorphous carbon coating has a flake-stacked structure.

12. The anode assembly of claim 1, wherein the anode has a thickness of from about 1 μm to about 100 μm.

13. The anode assembly of claim 1, wherein the anode has an apparent porosity of from about 20% to about 80%.

14. A lithium-ion battery, comprising:
an anode assembly comprising,
an anode comprising a first porous ceramic matrix comprising a plurality of pores,
a ceramic separator layer coupled to the anode, and
an amorphous carbon coating disposed on at least a portion of a surface of the first porous ceramic matrix;
an anode-side current collector coupled to at least a portion of the first porous ceramic matrix;
a cathode; and
at least one of:
an anode active material disposed in the pores of the anode, wherein the anode active material comprises lithium, and
a cathode active material disposed in the cathode.

15. The lithium-ion battery of claim 14, wherein the ceramic separator layer is substantially free of the amorphous carbon coating.

16. The lithium-ion battery of claim 14, wherein the amorphous carbon coating is electron conductive.

17. The lithium-ion battery of claim 16, wherein the amorphous carbon coating is ion conductive.

18. The lithium-ion battery of claim 14, wherein the amorphous carbon coating is disposed at least partially on the surface of the first porous ceramic matrix in one or more pores.

19. The lithium-ion battery of claim 14, wherein at least a portion of the amorphous carbon coating has a thickness of from about 1 nm to about 800 nm.

20. The lithium-ion battery of claim 19, wherein at least a portion of the amorphous carbon coating has a thickness of from about 150 nm to about 650 nm.

21. The lithium-ion battery of claim 20, wherein at least a portion of the amorphous carbon coating has a thickness of from about 250 nm to about 550 nm.

22. The lithium-ion battery of claim 14, wherein the amorphous carbon coating has an affinity for the anode active material.

23. The lithium-ion battery of claim 14, wherein the amorphous carbon coating has a flake-stacked structure.

24. The lithium-ion battery of claim 14, wherein the anode has a thickness of from about 1 μm to about 100 μm.

25. The lithium-ion battery of claim 14, wherein the anode has an apparent porosity of from about 20% to about 80%.

26. The lithium-ion battery of claim 14, wherein the anode active material has a nucleation overpotential of from about 0.1 mV to about 5 mV at 0.5 mA/cm².

27. The lithium-ion battery of claim 26, wherein the anode active material has a nucleation overpotential of from about 0.25 mV to about 2.5 mV at 0.5 mA/cm².

28. The lithium-ion battery of claim 27, wherein the anode active material has a nucleation overpotential of from about 0.5 mV to about 1.5 mV at 0.5 mA/cm².

29. The lithium-ion battery of claim 14, wherein the anode active material has a morphology substantially free of sharp edges after infiltration.

30. The lithium-ion battery of claim 14, wherein the cathode comprises a second porous ceramic matrix having pores.

31. The lithium-ion battery of claim 14, wherein the cathode has a thickness of from about 1 μm to about 100 μm.

32. The lithium-ion battery of claim 14, wherein the ceramic separator layer has a thickness of from about 1 μm to about 100 μm.

33. The lithium-ion battery of claim 14, wherein the cathode active material comprises sulfur.

34. A method of forming an anode assembly for a lithium-ion battery, comprising
(a) providing an anode and a ceramic separator layer coupled to the anode, wherein the anode comprises a porous ceramic matrix having pores; and
(b) disposing an amorphous carbon coating at least partially on a surface of the porous ceramic matrix to form the anode assembly.

35. The method of claim 34, wherein step (b) comprises disposing an amorphous carbon coating at least partially on the surface of the porous ceramic matrix in a vacuum chamber.

36. The method of claim 35, wherein step (b) comprises disposing an amorphous carbon coating at least partially on the surface of the porous ceramic matrix at room temperature.

37. The method of claim 34, wherein step (b) comprises disposing an amorphous carbon coating at least partially on the surface of the porous ceramic matrix via a sputtering device.

38. The method of claim 37, wherein the sputtering device comprises a carbon source.

39. The method of claim 38, wherein the carbon source is a graphite rod.

40. The method of claim 34, further comprising
(c) masking at least a portion of the ceramic separator layer prior to step (b).

41. The method of claim 34, wherein the amorphous carbon coating is electron conductive.

42. The method of claim 41, wherein the amorphous carbon coating is ion conductive.

43. The method of claim 34, wherein the amorphous carbon coating is disposed at least partially on the surface of the porous ceramic matrix in one or more pores.

44. The method of claim 34, wherein at least a portion of the amorphous carbon coating has a thickness of from about 1 nm to about 800 nm.

45. The method of claim 44, wherein at least a portion of the amorphous carbon coating has a thickness of from about 150 nm to about 650 nm.

46. The method of claim 45, wherein at least a portion of the amorphous carbon coating has a thickness of from about 250 nm to about 550 nm.

47. The method of claim 34, wherein the amorphous carbon coating has an affinity for an anode active material, wherein the anode active material comprises lithium.

48. The method of claim 34, wherein the amorphous carbon coating has a flake-stacked structure.

49. The method of claim 34, further comprising
(d) setting the amorphous carbon coating in a dry environment after step (b).
